(19) United States
(12) Patent Application Publication
(10) Pub. No.: US 2021/0229907 A1
(43) Pub. Date: Jul. 29, 2021

(54) DEVICE FOR SIGNIFYING WHETHER OR NOT A TRASH CAN HAS BEEN OPENED

(71) Applicant: Corwin Sampson, Boulder, CO (US)

(72) Inventor: Corwin Sampson, Boulder, CO (US)

(21) Appl. No.: 17/156,315

(22) Filed: Jan. 22, 2021

Related U.S. Application Data
(60) Provisional application No. 62/965,414, filed on Jan. 24, 2020.

(51) Int. Cl. B65F 1/16; B65F 1/02

(52) U.S. Cl. CPC B65F 1/1646; B65F 2210/138; B65F 1/02

(57) ABSTRACT

The present invention is directed to the signification of whether or not a trash can has been opened. This is achieved through a specialized device that snugly and rotatably attaches to the handle of a trash can in an initial position such that a protrusion on the device rests on a hinge. As the trash can opens, the hinge pushes the protrusion, causing the device to rotate with the lid and reach an alternate state. As the trash can closes, the device remains in the alternate state, thus acting as a visual indicator that the trash can had previously been opened since the device was attached. The device can then be rotated back into the initial state for future use.

### CROSS-REFERENCES TO RELATED APPLICATIONS

This application is a non-provisional and claims benefit of U.S. Patent Application No. 62/965,414, filed Jan. 24, 2020, the specification(s) of which is/are incorporated herein in their entirety by reference.

### BACKGROUND OF THE INVENTION

While community-distributed trash cans and recycling bins are emptied by garbage trucks on a pre-determined schedule, external circumstances may lead to one's trash can being missed by the garbage truck. In this situation, the trash can must be approached and checked to see if the trash was actually emptied out of it. Thus, a need exists for a device to visually indicate from afar whether or not a trash can has been emptied and is ready to bring in from the curb.

### FIELD OF THE INVENTION

The present invention is directed to the signification of whether or not a trash can has been opened using a specialized device.

### BRIEF SUMMARY OF THE INVENTION

It is an objective of the present invention to provide a device that allows for the signification of whether a trash can has been opened or not, as specified in the independent claims. Embodiments of the invention are given in the dependent claims. Embodiments of the present invention can be freely combined with each other if they are not mutually exclusive.

In some embodiments, the present invention features a device for signifying whether or not a trash can has been opened. The device may comprise a tubular structure, an arm that projects away from the tubular structure and has a first end and a second end, a protrusion disposed at the first end of the arm, and a flag disposed at the second end of the arm. The tubular structure may snugly and rotatably attach to a handle of the trash can such that the protrusion rests on a hinge. The hinge may pivotably connect the handle to a lid of the trash can such that opening the trash can by rotating the lid by the hinge will cause the hinge to push the device around the handle into a new position. Closing the lid will leave the device in the new position.

In another embodiment, the present invention features a device for signaling whether or not a trash can has been opened. The device may comprise a handle attachment, an arm attached orthogonally to the handle attachment, a flag disposed on the arm, and an extension disposed on the handle attachment or the arm. The handle attachment can be snugly and rotatably attached to the handle such that the flag is in a first position, e.g. the arm may be upright relative to the ground, and the extension rest upon the hinge or lid. Opening of the lid moves the extension, which causes the handle attachment to rotate and move the flag to a second position indicating that the lid has been opened. For example, the arm is moved from being upright to being in an angle or a horizontal position.

One of the unique and inventive technical features of the present invention is the protrusion disposed at the first end of the arm that rests upon the hinge of the trash can. Without wishing to limit the invention to any theory or mechanism, it is believed that the technical feature of the present invention allows the arm to rotate around the device when the trash can lid is opened, thus signifying that the trash can has been opened. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a side view of an embodiment of the present invention. A device of the embodiment comprises a tubular structure, an arm that projects away from the tubular structure and has a first end and a second end, a protrusion disposed at the first end of the arm, and a flag disposed at the second end of the arm.

FIG. 1B shows an isometric view of the embodiment of the present invention.

FIG. 2A shows the device of the present invention attached to the handle of a trash can. The trash can comprise a container, a lid, a handle, and a hinge. The protrusion of the device rests on one of the hinges of the trashcan.

FIG. 2B shows the device of the present invention attached to the handle of the trash can on the near side.

FIG. 3 shows a method of using the device of the present invention. The device snugly and rotatably attaches to the handle of the trash can by the tubular structure and the protrusion rests on a hinge. As the trash can opens, the hinge pushes the arm and the flag around the handle into a new position. The device stays in this new position even after the trash can is closed.

FIG. 4 shows a first alternate embodiment of the present invention. A device of the first alternate embodiment comprises a tubular structure, a first arm that projects away from the tubular structure, a second arm that projects away from the tubular structure and is perpendicular to both the tubular structure and the first arm, and a flag disposed on the first arm.

FIG. 5 shows a method of the first alternate embodiment of the present invention. The device snugly and rotatably attaches to a handle of a trash can by the tubular structure and the second arm rests on the lid. As the trash can opens, the lid pushes the second arm, rotating the first arm around the handle into a new position. The device stays in this new position even after the trash can is closed.

FIG. 6 shows a second alternate embodiment of the present invention attached to a handle of a trash can. A device of the second alternate embodiment may comprise a tubular structure, a first arm that projects away from the tubular structure, a second arm that projects away from the tubular structure in the same direction as the tubular structure, and a flag disposed on the first arm.

FIG. 7 shows a method of the second alternate embodiment of the present invention. The device snugly and rotatably attaches to the handle of the trash can by the tubular structure and the second arm rests on a hinge. As the trash can opens, the hinge pushes the second arm, rotating the first arm around the handle into a new position. The device stays in the new position even after the trash can is closed.

FIGS. 8A-8B show another embodiment of the present invention. The device comprise a tubular structure, an arm having a first end and a second end where the arm projects orthogonally away from the tubular structure, a flag disposed at the second end of the arm, and a second flag disposed near the first end of the arm. The tubular structure attaches the device to the handle of the trashcan, and the second flag rests on the hinge such that the device is in an initial position where the first flag is upright. When the lid is opened, the hinge rotates the device by pushing the second flag such that the arm rotates and is pushed into an alternate position, where the first flag faces downward.

### DETAILED DESCRIPTION OF THE INVENTION

Following is a list of elements corresponding to a particular element referred to herein:

100 device to notify whether or not a trash can has been opened

101 tubular structure

102 arm

103 protrusion

104 flag

105 second arm of the device to rest on lid (exemplary embodiment)

106 second arm of the device to rest on hinge (exemplary embodiment)

110 first end of arm

111 second end of arm

200 trash can

201 trash can handle

202 trash can hinge

203 trash can lid

210 trash can container

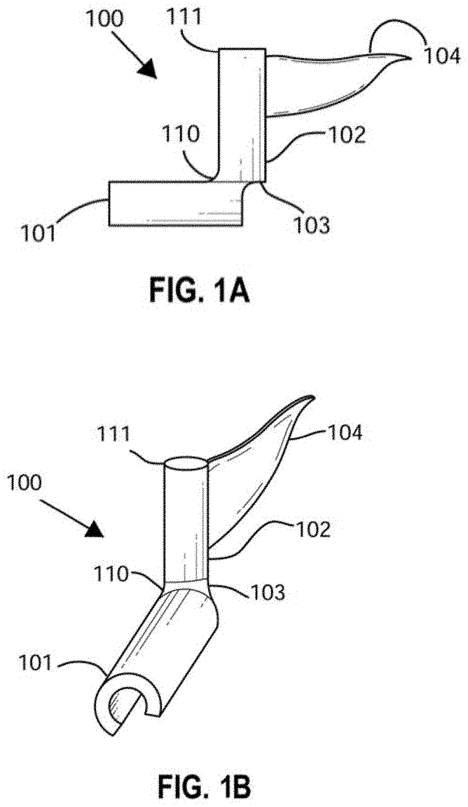

Referring to FIGS. 1A-1B, the present invention features a device (100) for signifying whether or not a trash can (200) has been opened. In some embodiments, the device may comprise a tubular structure (101) having a first end and a second end and a protrusion (103) disposed at a first end of the tubular structure, and an arm (102) attached to the protrusion (103), the arm (102) having a first end (110) and a second end (111). The first end (110) of the arm (102) is attached to the tubular structure (101) such that the arm (102) is orthogonal to the tubular structure (101), and a flag (104) is disposed on the arm (102). The trash can (200) comprises a container (210), a handle (201) externally attached lengthwise to a lip of the container (210), a lid (203) that covers the container (210), and a hinge (202) that pivotably connects the lid (203) to the handle (201), and the lid (203) rotates around the handle (201) by the hinge (202) to open or close the trash can (200). The tubular structure (101) may snugly and rotatably attach to the handle (201) of the trash can (200), and the protrusion (103) may rest on a hinge (202) of the trash can (200). The flag (104) is in a first position when the device is attached to the handle (201), and when the lid (203) is opened, the rotation of the hinge (202) causes the tubular structure (101) to rotate the flag (104) to a second position, indicating the lid (203) has been opened. In other embodiments, the flag (104) is disposed at the second end (111) of the arm (102).

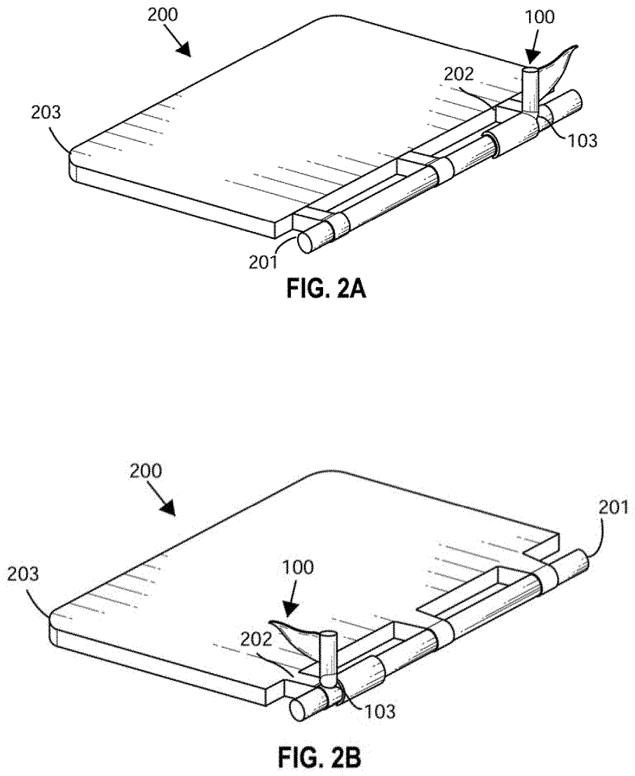

Referring to FIG. 2, the present invention features a system for signifying whether or not a trash can (200) has been opened. In some embodiments, the system may comprise a trash can (200). The trash can (200) may further comprise a container (210), a lid (203), a handle (201), and a hinge (202). The handle (201) may be externally attached lengthwise to a lip of the container (210). The lid (203) may cover the container (210), and the hinge (202) may pivotably connect the lid (203) to the handle (201). Opening or closing the trash can (200) may entail rotating the lid (203) around the handle (201) by the hinge (202). The system may further comprise a device (100). The device may comprise a tubular structure (101) having a first end and a second end and a protrusion (103) disposed ata first end of the tubular structure, and an arm (102) attached to the protrusion (103), the arm (102) having a first end (110) and a second end (111). The first end (110) of the arm (102) is attached to the tubular structure (101) such that the arm (102) is orthogonal to the tubular structure (101), and a flag (104) is disposed on the arm (102). The tubular structure (101) may snugly and rotatably attach to the handle (201) of the trash can (200), and the protrusion (103) may rest on the hinge (202).

In some embodiments, the device (100) may be snugly and rotatably attached to the handle (201) by the tubular structure (101) in an initial position such that the protrusion (103) rests on the hinge (202). When the trash can (200) is opened, the protrusion (103) may be pushed by the hinge (202), causing the tubular structure (101) to rotate the flag (104) in a same direction as the lid (203) around the handle (201) into an alternate position. When the trash can (200) is closed, the device (100) may remain in the alternate position.

In some embodiments, the initial position of the flag (104) may signify that the trash can (200) has not been opened since the device (100) was attached and the alternate position signifies that the trash can (200) has been opened since the device (100) was attached. The initial position of the device (100) may comprise the flag (104) being perpendicular to the ground, and the device (100) may be reset from the alternate position back into the initial position by rotating it around the handle (201) towards the lid (203). In some embodiments, the tubular structure (101) is a pipe with an opening that runs longitudinally along an edge of the pipe, and the arm (102) is a pipe. In further embodiments, the flag (104) is disposed at the second end (111) of the arm (102).

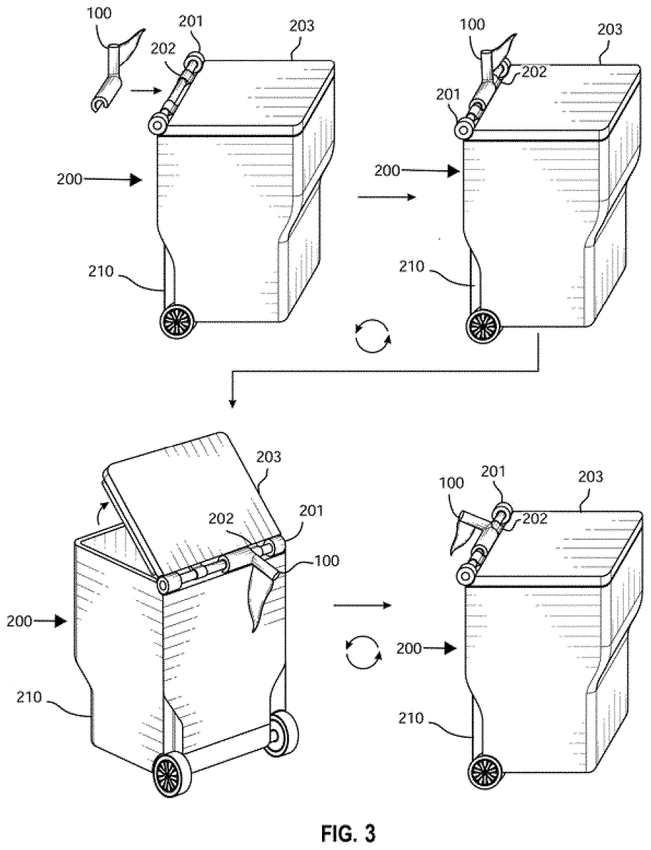

Referring to FIG. 3, the present invention features a method for signifying whether or not a trash can (200) has been opened. In some embodiments, the method may comprise snugly and rotatably attaching a device (100), by a tubular structure (101), to a handle (201) of the trash can (200) in an initial position, such that a protrusion (103) at a first end (110) of an arm (102) rests on a hinge (202) of the trash can (200). The hinge (202) may rotatably wrap around the handle (201) and extend to a lid (203). The method may further comprise opening the trash can (200) such that the lid (203) rotates around the handle (201) by the hinge (202), and pushing the protrusion (103) by the hinge (202) such that the tubular structure (101) rotates the flag (104) with the lid (203) around the handle (201) into an alternate position. Finally, the method may comprise closing the trash can (200) such that the device (100) is left in the alternate position.

In some embodiments, the initial position of the flag (104) may signify that the trash can (200) has not been opened since the device (100) was attached and the alternate position may signify that the trash can (200) has been opened since the device (100) was attached. The initial position may comprise the flag (104) being perpendicular to the ground and the device (100) may be reset to the initial position from the alternate position to signify the next time that the trash can (200) is opened by rotating the device (100) around the handle (201) towards the lid (203). In some embodiments the tubular structure (101) is a pipe with an opening that runs longitudinally along an edge of the pipe, and the arm (102) is a pipe.

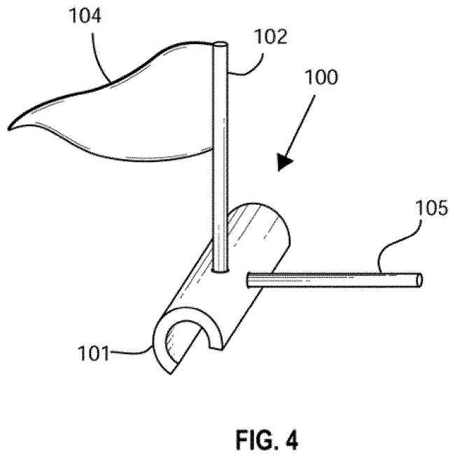

Referring to FIG. 4, an embodiment of the present invention features a device for signifying whether or not a trash can (200) has been opened. The device may comprise a tubular structure (101), a first arm (102) that projects orthogonally away from the tubular structure (101), a second arm (105) that projects away from the tubular structure (101) such that the second arm (105) is perpendicular to the tubular structure (101) and the arm (102), and a flag disposed on the first arm (102). The tubular structure (101) may snugly and rotatably attach to a handle (201) of the trash can (200), and the second arm (105) may rest on a lid (203) of the trash can (200). The tubular structure (101) may be a first pipe with an opening that runs longitudinally along an edge of the pipe, the first arm (102) may be a second pipe, and the second arm (105) may be a third pipe. The first arm (102) and the second arm (105) may both be perpendicular to the tubular structure (101) and perpendicular to each other. The flag (104) is in a first position when the device is attached to the handle (201), and when the lid (203) is opened, the rotation of the hinge (202) causes the tubular structure (101) to rotate the flag (104) to a second position, indicating the lid (203) has been opened.

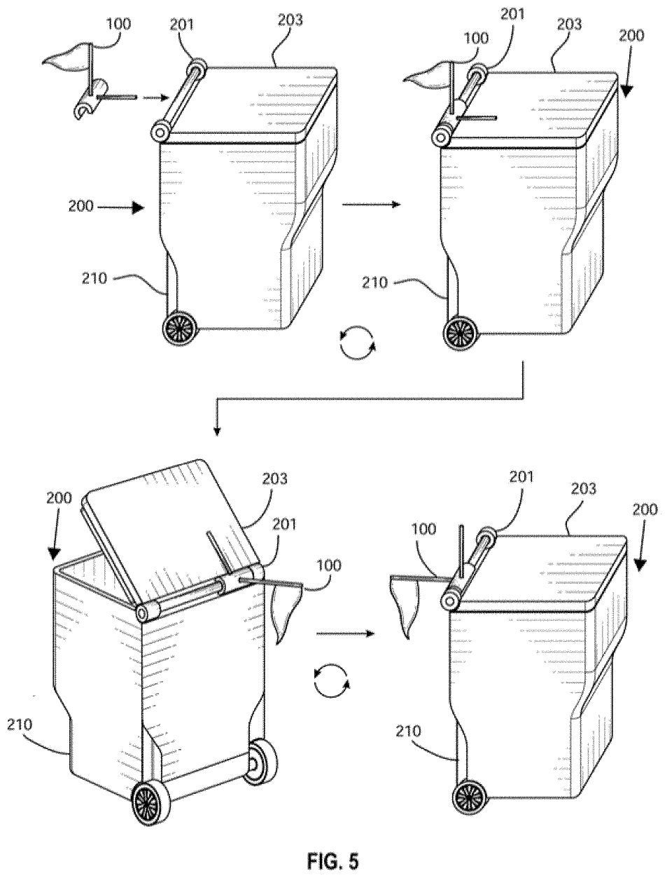

Referring to FIG. 5, an embodiment of the present invention features a method for signifying whether or not a trash can (200) has been opened. The method may comprise snugly and rotatably attaching a device (100), by a tubular structure (101) to a handle (201) of the trash can (200) in an initial position, such that the second arm (105) rests on a lid (203). The method may further comprise opening the trash can (200) such that the lid (203) rotates around the handle (201), and pushes the second arm (105) by the lid (203) such that the flag (104) is rotated with the lid (203) around the handle (201) into an alternate position. Finally, the method may further comprise closing the trash can (200) such that the flag (104) is left in the alternate position.

The initial position of the flag (104) may signify that the trash can (200) has not been opened since the device (100) was attached and the alternate position may signify that the trash can (200) has been opened since the device (100) was attached. The initial position may comprise the flag (104) being perpendicular to the ground and the device (100) may be reset to the initial position from the alternate position to signify the next time that the trash can (200) is opened by rotating the flag (104) around the handle (201) towards the lid (203). The tubular structure (101) may be a first pipe with an opening that runs longitudinally along an edge of the pipe, the first arm (102) may be a second pipe, and the second arm (105) may be a third pipe. The first arm (102) and the second arm (105) may both be perpendicular to the tubular structure (101) and perpendicular to each other.

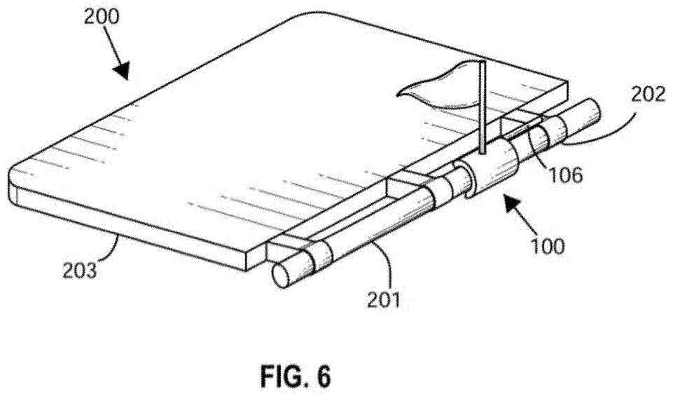

Referring to FIG. 6, an embodiment of the present invention features a device for signifying whether or not a trash can (200) has been opened. The device may comprise a tubular structure (101), a first arm (102) that projects orthogonally from the top of the tubular structure (101), a second arm (106) that projects from the side of the tubular structure (101), and a flag disposed on the first arm (102). The tubular structure (101) may snugly and rotatably attach to a handle (201) of the trash can (200), and the second arm (106) may rest on a hinge (202) of the trash can (200). The hinge (202) may rotatably wrap around the handle (201) and connect to a lid (203). The tubular structure (101) may be a first pipe with an opening that runs longitudinally along an edge of the pipe, the first arm (102) may be a second pipe, and the second arm (106) may be a third pipe. The second arm (106) may be linear to the tubular structure (101) and the first arm (102) may be perpendicular to both the tubular structure (101) and the second arm (106).

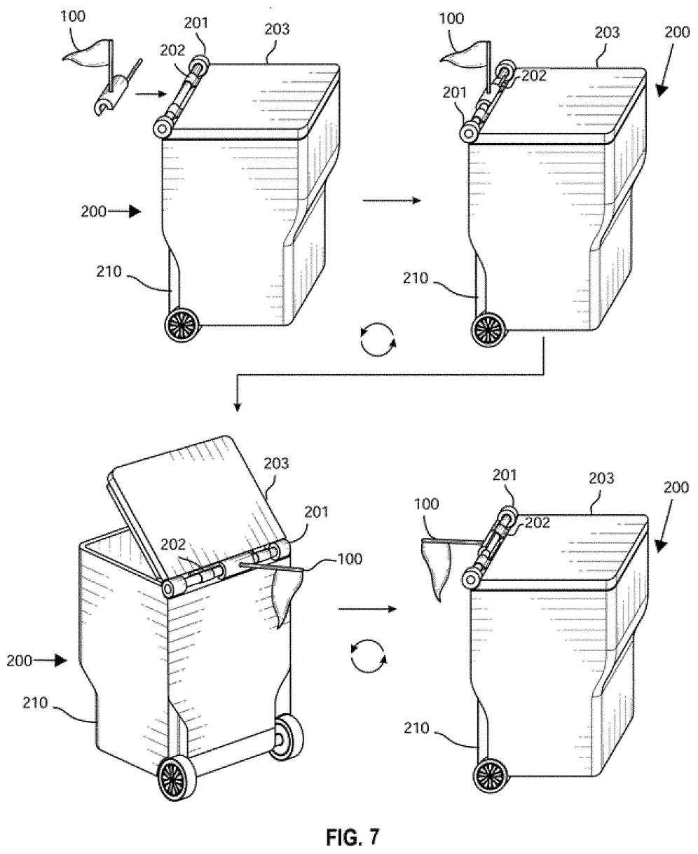

Referring to FIG. 7, an embodiment of the present invention features a method for signifying whether or not a trash can (200) has been opened. The method may comprise snugly and rotatably attaching a device (100), by a tubular structure (101) to a handle (201) of the trash can (200) in an initial position, such that the second arm (106) rests on a hinge (202). The hinge (202) may rotatably wrap around the handle (201) and extend to a lid (203). The method may further comprise opening the trash can (200) such that the lid (203) rotates around the handle (201) by the hinge (202), and pushes the second arm (105) by the hinge (202) such that the flag (104) is rotated with the lid (203) around the handle (201) into an alternate position. Finally, the method may further comprise closing the trash can (200) such that the flag (104) is left in the alternate position.

The initial position of the flag (104) may signify that the trash can (200) has not been opened since the device (100) was attached and the alternate position may signify that the trash can (200) has been opened since the device (100) was attached. The initial position may comprise the first arm (102) being perpendicular to the ground and the device (100) may be reset to the initial position from the alternate position to signify the next time that the trash can (200) is opened by rotating the flag (104) around the handle (201) towards the lid (203). The tubular structure (101) may be a first pipe with an opening that runs longitudinally along an edge of the pipe, the first arm (102) may be a second pipe, and the second arm (105) may be a third pipe. The second arm (106) may be linear to the tubular structure (101) and the first arm (102) may be perpendicular to both the tubular structure (101) and the second arm (106).

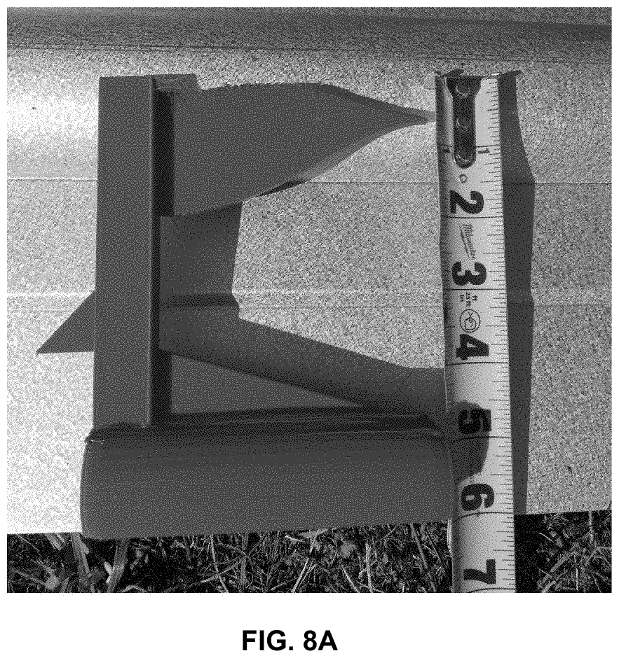

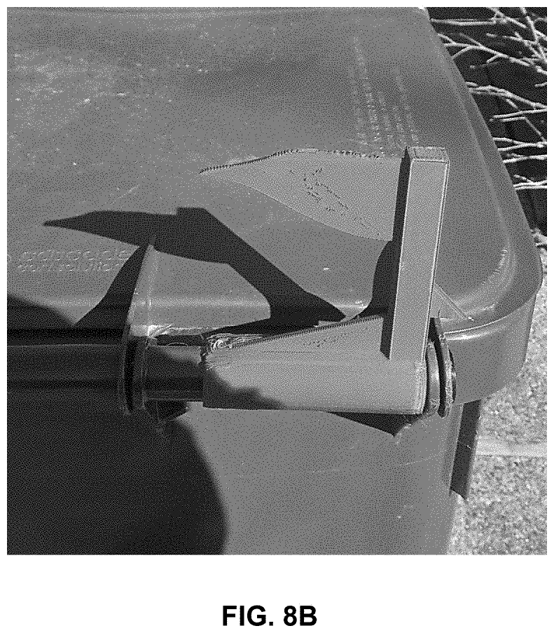

Referring now to FIGS. 8A-8B, another embodiment of the present invention feature a device comprising a tubular structure, an arm having a first end and a second end where the arm projects orthogonally away from the tubular structure, a flag disposed at the second end of the arm, and a second flag disposed near the first end of the arm. In preferred embodiments, the second flag faces an opposite direction from the first flag and rests on a hinge when the device is attached to a trash can. The tubular structure may snugly and rotatably attach to a handle of the trash can. The hinge may rotatably wrap around the handle and connect to a lid of the trash can. The tubular structure may be a first pipe with an opening that runs longitudinally along an edge of the pipe, the first arm may be a second pipe. In some embodiments, the device is attached to the trash can in an initial position. In further embodiments, when the lid of the trash can is opened, the hinge pushes the device by the second flag such that the arm rotates and is moved into an alternate position. In some embodiments, the initial position is when the first flag is in an upright position, and the alternate position is when the first flag is facing downwards.

As used herein, the term “about” refers to plus or minus 10% of the referenced number. Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A device (100) for signifying whether or not a trash can (200) has been opened, the device comprising:
a. a tubular structure (101) having a first end and a second end;
b. a protrusion (103) disposed at the first end of the tubular structure; and
c. an arm (102) having a first end (110) and a second end (111), wherein the first end (110) of the arm is attached to the protrusion (103) such that the arm (102) is orthogonal to the tubular structure (101), wherein a flag (104) is disposed on the arm (102);
wherein the trash can (200) comprises a container (210), a handle (201) externally attached to the container (210), a lid (203) that covers the container (210), and a hinge (202) that pivotably connects the lid (203) to the handle (201), wherein the lid (203) rotates around the handle (201) by the hinge (202) to open or close the trash can (200);
wherein the tubular structure (101) snugly and rotatably attaches to the handle (201) and the protrusion (103) rests on the hinge (202),
wherein the flag (104) is in a first position when the device is attached to the handle (201), wherein when the lid (203) is opened, the tubular structure (101) rotates and the flag (104) is moved to a second position indicating that the lid (203) has been opened.

2. The device (100) of claim 1, wherein the tubular structure (101) comprises an opening that runs longitudinally along an edge of the tubular structure.

3. The device (100) of claim 1, wherein the flag (104) is disposed at or near the second end (111) of the arm.

4. A device (100) for signifying whether or not a trash can (200) has been opened, the device comprising:
a. a handle attachment (101);
b. an arm (102) attached orthogonally to the handle attachment (101), wherein a flag (104) is disposed on the first arm (102); and
c. an extension (105) disposed on the handle attachment (101) or the arm (102);
wherein the trash can (200) comprises a container (210), a lid (203) that covers the container (210), a handle (201) attached to the container (210), and a hinge (202) that pivotably connects the lid (203) to the handle (201);
wherein the handle attachment (101) snugly and rotatably attaches to the handle (201) such that the flag (104) is in a first position and the extension (105) rest upon the hinge (202) or lid (203);
wherein opening of the lid (203) moves the extension (105), which causes the handle attachment (101) to rotate and move the flag (104) to a second position indicating that the lid (203) has been opened.

5. A system for signifying whether or not a trash can (200) has been opened, the system comprising:
a. the trash can (200) comprising:
i. a container (210);
ii. a lid (203) that covers the container (210);
iii. a handle (201) externally attached lengthwise to a lip of the container (210); and
iv. a hinge (202) that pivotably connects the lid (203) to the handle (201), wherein the lid (203) rotates around the handle (201) by the hinge (202) to open or close the trash can (200);
b. a device (100), the device comprising:
i. a tubular structure (101) having a first end and a second end, wherein a protrusion (103) is disposed at a first end of the tubular structure; and
ii. an arm (102) attached to the protrusion (103), the arm (102) having a first end (110) and a second end (111), wherein the first end (110) is attached to the tubular structure (101) such that the arm (102) is orthogonal to the tubular structure (101), wherein a flag (104) is disposed on the arm (102);
wherein the device (100) is snugly and rotatably attached to the handle (201) by the tubular structure (101), wherein the arm (102) and the flag (104) are in an initial position, wherein the protrusion (103) rests on the hinge (202);
wherein when the trash can (200) is opened, the protrusion (103) is pushed by the hinge (202), such that the tubular structure (101) rotates the flag (104) in a same direction as the lid (203) around the handle (201) into an alternate position; and
wherein, when the trash can (200) is closed, the flag (104) remains in the alternate position.

6. The system of claim 5, wherein:
a. the initial position of the flag (104) signifies that the trash can (200) has not been opened since the device (100) was attached to the trash can (200); and
b. the alternate position signifies that the trash can (200) has been opened since the device (100) was attached to the trash can (200).

7. The system of claim 6, wherein the initial position of the device (100) is when the flag (104) is perpendicular to the ground.

8. The system of claim 5, wherein the device (100) can be reset to the initial position from the alternate position to signify the next time that the trash can (200) is opened, the procedure for resetting comprising rotating the device (100) around the handle (201) towards the lid (203).

9. The system of claim 5, wherein the tubular structure (101) is a pipe with an opening that runs longitudinally along an edge of the pipe.

10. The system of claim 5, wherein the arm (102) is a pipe.

11. The system of claim 5, wherein the flag (104) is disposed at the second end (111) of the arm (102).

12. A method for signifying whether or not a trash can (200) has been opened, the method comprising attaching the device (100) of claim 1 to a handle (201) of the trash can (200) by the tubular structure (101), wherein the device (100) is in an initial position, wherein the protrusion (103) rests on the hinge (202) of the trash can (200), wherein the hinge rotatably wraps around the handle (201) and extends to the lid (203) of the trash can (200);
wherein when opening the trash can (200), the lid (203) rotates around the handle (201) by the hinge (202) and the protrusion (103) is pushed by the hinge (202) such that the tubular structure (101) rotates the flag (104) in the same direction as the lid (203) into an alternate position, wherein when closing the trash can (200), the flag (104) is left in the alternate position.

13. The method of claim 12, wherein:
a. the initial position of the flag (104) signifies that the trash can (200) has not been opened since the device (100) was attached to the trash can (200), and
b. the alternate position signifies that the trash can (200) has been opened since the device (100) was attached to the trash can (200).

14. The method of claim 13, wherein the initial position is when the flag (104) is perpendicular to the ground.

15. The method of claim 12, wherein the device (100) can be reset to the initial position from the alternate position to signify the next time that the trash can (200) is opened, the method for resetting comprising rotating the arm (102) around the handle (201) towards the lid (203).

16. The method of claim 12, wherein the tubular structure (101) is a pipe with an opening that runs longitudinally along an edge of the pipe.

17. The method of claim 12, wherein the arm (102) is a pipe.
